(19) United States
(12) Patent Application Publication
(10) Pub. No.: US 2025/0288484 A1
(43) Pub. Date: Sep. 18, 2025

(54) FOOT PHYSIOTHERAPY DEVICE

(71) Applicant: DONGGUAN YICHANG ELECTRONICS CO., LTD, DONGGUAN CITY (CN)

(72) Inventor: Yinxing Huang, Dongguan City (CN)

(21) Appl. No.: 18/830,498

(22) Filed: Sep. 10, 2024

(30) Foreign Application Priority Data
Mar. 14, 2024 (CN) 2024204906758

(51) Int. Cl. A61H 15/00; A61H 23/00; A61H 39/04

(52) U.S. Cl. CPC A61H 15/00; A61H 23/006; A61H 39/04; A61H 2015/0042; A61H 2201/0107; A61H 2201/0119; A61H 2201/0169; A61H 2201/0214; A61H 2201/0221; A61H 2201/1454; A61H 2205/125

(57) ABSTRACT

The present disclosure includes a foot physiotherapy device, which relates to the field of physiotherapy tools. The foot physiotherapy device includes a support structure and at least two physiotherapy tools, wherein the support structure includes a first support holder and a second support holder arranged opposite each other, the first support holder being provided with a first arrangement surface and at least two first support surfaces, and the second support holder being provided with a second arrangement surface and at least two second support surfaces; and each of the physiotherapy tools has one end arranged on the first arrangement surface, and the other end thereof is arranged on the second arrangement surface. In this way, different physiotherapy functions are achieved.

### TECHNICAL FIELD

The present disclosure relates to the field of physiotherapy tools, and in particular to a foot physiotherapy device.

### BACKGROUND ART

Plantar fasciitis is caused by long-term action of overload pressure on the sole of the human foot. Since acute or chronic injuries of the plantar fasciitis can lead to plantar pain, this disease brings a large burden on the life and work of a patient. At present, there are three main types of massage products on the market for relieving the pain caused by plantar fasciitis and promoting rehabilitation, including a ball-type foot massager, a roller-type foot massager and an abacus-type foot massager. The three products are based on the main principle of making use of the shape thereof, such as having protrusions, to press, stretch and stimulate the sole to achieve the effects of stimulating acupoints to relieve pain and stretching the plantar fascia. However, the ball-type, roller-type and abacus-type foot massagers available on the market have their own defects, and the main problems will be described as follows.

1. The pain relief effect is not obvious. The ball-type, roller-type and abacus-type foot massagers all make use of their own shape, such as having protrusions, to compress and stretch the fascia when a user steps on the product or push and pull the product with their sole. However, the stimulation on the surface of the sole cannot have direct action on the nerves in the deeper layer that cause pain, thus achieving a limited pain relief effect.

2. The acupoints are not stimulated properly. The ball-type and roller-type foot massagers have a large-area surface arch design, and thus cannot accurately stimulate the acupoints on the sole in actual use and can only have the effect of pressing the fascia. Even some of the products are oversized, such that stepping on the product achieves the equivalent effect to stepping on a flat surface, and thus the pressing actually has no action on the plantar fascia, which cannot achieve the pressing and stretching effect.

3. The product has large noise and is easy to wear. Since the abacus-type foot massager is made of bamboo, and the shaft core on which beads are stringed is also made of bamboo (or a wooden stick), the product will generate large noise when the user steps on or vigorously pushed and pulled the product with the sole, and the wear of the shaft core is also inevitable, such that long-term use will lead to increased friction of the shaft core and reduced rolling effect, and eventually the product is unable to continue to use. The ball-type and roller-type foot massagers are made of silicone or rubber and thus have higher wear resistance. However, since the product needs to be placed on the floor and to roll on and rub against the floor during use, the hard and rough floor will also cause irreversible wear to the product surface, which cannot guarantee the durability of the product.

4. The experience during use is poor. The ball-type and roller-type foot massagers have no limit on the floor, and thus the product will move as the sole steps on or pushes and pulls the product. Since the product moves back and forth on the sole, there are high requirements on the user's motion control, such that for elderly users or users with motor incoordination, the product is difficult to use, and a little carelessness will cause the product to be out of control and roll away. The abacus-type foot massager needs a large pushing force for rolling, and is also prone to movement as a whole, resulting in poor user experience.

5. The products are not suitable for the middle-aged and elderly users. Since the common ball-type, roller-type and abacus-type foot massagers are prone to movement, the user usually needs to stand during use to achieve a high level of motion control. This undoubtedly increases the physical exertion of the middle-aged and elderly users. The ball-type and roller-type foot massagers are more prone to movement, and even increase the risk of falling of the user.

6. The products have single function. The ball-type foot massager can massage the fascia, but cannot stimulate the acupoints. The roller-type and abacus-type foot massagers have spikes or protrusions that can stimulate the acupoints, but cannot massage the fascia. They have single function.

### SUMMARY

In order to overcome the deficiencies of the prior art, the present disclosure provides a foot physiotherapy device in which different types of physiotherapy tools can be combined to implement different physiotherapy functions and achieve better effect in pain relief and adjunctive treatment on plantar fasciitis.

The present disclosure is implemented through the following technical solution:
a foot physiotherapy device, including a support structure and at least two physiotherapy tools; wherein each physiotherapy tool can implement muscle massage on the sole in a different form; the support structure includes a first support holder and a second support holder arranged opposite each other, the first support holder being provided with a first arrangement surface and at least two first support surfaces, and the second support holder being provided with a second arrangement surface and at least two second support surfaces; each of the physiotherapy tools has one end arranged on the first arrangement surface, and the other end thereof is arranged on the second arrangement surface; the first support surfaces correspond to the second support surfaces on a one-to-one basis, and each of the first support surfaces and the corresponding second support surface form stable support when supporting the foot physiotherapy device; and the different physiotherapy tools are switched to a usage position by means of changing the different first support surfaces and the different second support surfaces to support the foot physiotherapy device.

In the description of the present disclosure, unless otherwise explicitly defined, the words such as “arrange”, “mount” and “connect” should be understood in a broad sense, and those skilled in the art can reasonably determine the specific meanings of the above words in the present disclosure with reference to the specific contents of the technical solutions.

### BRIEF DESCRIPTION OF THE DRAWINGS

FIG. 1 is a perspective view of a foot physiotherapy device according to an embodiment of the present disclosure from a first perspective;

FIG. 2 is a perspective view of the foot physiotherapy device according to an embodiment of the present disclosure from a second perspective;

FIG. 3 is a perspective view of the foot physiotherapy device according to an embodiment of the present disclosure from a third perspective;

FIG. 4 is a partial schematic structural diagram of the foot physiotherapy device according to an embodiment of the present disclosure;

FIG. 5 is an enlarged view of part A in FIG. 4; and

FIG. 6 is another partial schematic structural diagram of the foot physiotherapy device according to an embodiment of the present disclosure.

List of reference signs: 1. support structure; 2. physiotherapy tool; 3. first support holder; 4. second support holder; 5. first arrangement surface; 6. first support surface; 7. second arrangement surface; 8. second support surface; 9. silent bearing; 10. temperature lowering and pain relief tool; 11. temperature lowering component; 12. tube; 13. cap; 14. internal space; 15. mace-shaped acupoint massage tool; 16. first shaft core; 17. first massage sleeve; 18. bump; 19. oval hammer massage tool; 20. second shaft core; 21. second massage sleeve; 22. protrusion; 23. movable member; 24. retaining structure; 25. first elastic structure; 26. pressing device; 27. pressing member; 28. second elastic structure; 29. guide groove; 30. anti-slip structure.

### DETAILED DESCRIPTION OF EMBODIMENTS

In the description of the present disclosure, it should be understood that orientation or position relationships indicated by terms “upper”, “lower”, “front”, “rear”, “left”, “right”, etc. are orientation or position relationships as shown in the accompanying drawings, and these terms are just used to facilitate description of the present disclosure and simplify the description, rather than indicating or implying that the mentioned device or element must have a specific orientation and must be constructed and operated in a specific orientation, and thus cannot be construed as a limitation to the present disclosure.

In the description of the present disclosure, “several” means one or more, “a plurality of” means two or more, “greater than”, “less than”, “over”, etc. are construed as excluding the number, and “above”, “below”, “within”, etc. are construed as including the number. The terms “first” and “second” in the description are merely intended to distinguish technical features, and cannot be construed as indicating or implying relative importance or implicitly indicating a number of the indicated technical features or implicitly indicating a sequence relationship of the indicated technical features.

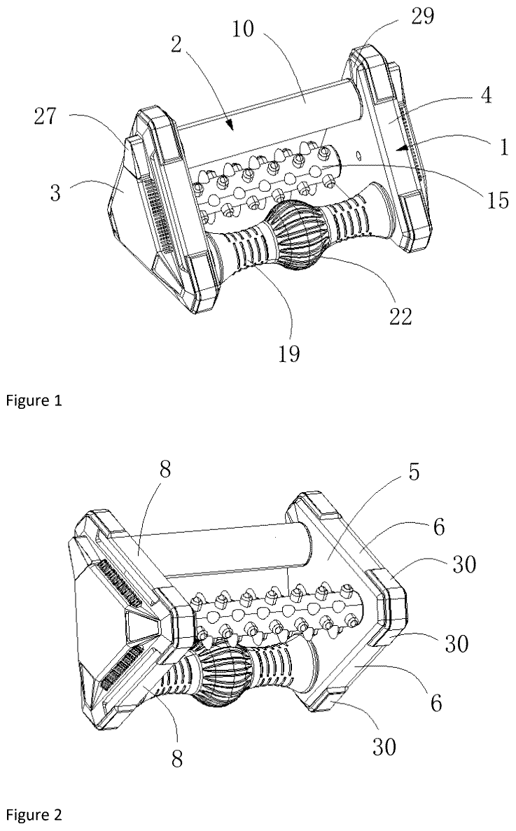

Referring to FIGS. 1 to 3, according to a preferred embodiment of a foot physiotherapy device of the present disclosure, the foot physiotherapy device includes a support structure 1 and at least two physiotherapy tools 2. The support structure 1 includes a first support holder 3 and a second support holder 4 arranged opposite each other, the first support holder 3 being provided with a first arrangement surface 5 and at least two first support surfaces 6, and the second support holder 4 being provided with a second arrangement surface 7 and at least two second support surfaces 8. Each of the physiotherapy tools 2 has one end arranged on the first arrangement surface 5, and the other end thereof is arranged on the second arrangement surface 7. The first support surfaces 6 correspond to the second support surfaces 8 on a one-to-one basis, and each first support surface 6 and the corresponding second support surface 8 can form stable support when supporting the foot physiotherapy device. The different physiotherapy tools 2 can be switched to a usage position by means of changing the different first support surfaces 6 and second support surfaces 8 to support the foot physiotherapy device.

The foot physiotherapy device of the present disclosure is provided with the at least two physiotherapy tools 2 to achieve different physiotherapy functions, and a user can select different physiotherapy tools 2 for comprehensive physiotherapy, thereby achieving better effect in pain relief and adjunctive treatment on plantar fasciitis. When it is needed to use the corresponding physiotherapy tools 2, the different physiotherapy tools 2 can be switched to the usage position by means of only changing the different first support surfaces 6 and second support surfaces 8 to support the foot physiotherapy device, which is simple to operate and improves the user experience. During use of the foot physiotherapy device of the present disclosure, the physiotherapy tool 2 does not directly rub against the floor, which can not only reduce the wear of the physiotherapy tool 2, but also prevent the physical physiotherapy tool 2 from moving and thus causing the user to fall, thereby improving the safety.

As preferred embodiments, the foot physiotherapy device of the present disclosure may also have the following additional technical features.

In an optional embodiment, the at least one physiotherapy tool 2 has a component that is rollable by itself. In this way, during use of the physiotherapy tool 2 by the user, when the foot slides back and forth on, presses and pushes, and steps on the component of the physiotherapy tool 2, the foot physiotherapy device will not move during use by the user, which reduces the risk of the falling of the user and can achieve better foot physiotherapy effect, thereby improving the user experience. In other embodiments, at least one physiotherapy tool 2 may be arranged on the support structure 1 in a rollable manner.

Referring to FIG. 4, in an optional embodiment, a silent bearing 9 is provided inside the at least one physiotherapy tool 2, and the corresponding component of the physiotherapy tool 2 is rollable by means of the silent bearing 9, which can improve the silence effect during use of the foot physiotherapy device, thereby improving the user experience. In other embodiments, no silent bearing 9 is provided inside the physiotherapy tools 2.

In an optional embodiment, the at least one physiotherapy tool 2 is detachably arranged on the support structure 1. In this way, when the physiotherapy tool 2 needs to be cleaned, repaired or replaced, the physiotherapy tool 2 can be removed from the support structure 1, which is more conducive to operation in the above process and is more efficient. In other embodiments, the at least one physiotherapy tool 2 has a component that can be detachably arranged.

Referring to FIGS. 1 to 3, in an optional embodiment, the foot physiotherapy device includes three physiotherapy tools 2, wherein the first support holder 3 and the second support holder 4 are arranged in the form of a transverse triangular prism; the first support holder 3 and the second support holder 4 are each provided with three support surfaces, the three support surfaces of the first support holder 3 being respectively located on three transverse planes corresponding to the first support holder 3, and the three support surfaces of the second support holder 4 being respectively located on three transverse planes corresponding to the second support holder 4; and each physiotherapy tool 2 has one end arranged at a position of the first arrangement surface 5 close to a corner, and the other end thereof is arranged at a corresponding position of the second arrangement surface 7 close to a corner. Based on the above structure, when it is needed to use the corresponding physiotherapy tools 2, the different physiotherapy tools 2 can be switched to the usage position by means of only changing the different first support surfaces 6 and second support surfaces 8 to support the foot physiotherapy device, that is, the corresponding physiotherapy tool 2 needed is located at the top, which is simple to operate and improves the user experience. In addition, the above structure has better structural stability, and does not easily damage. In other embodiments, the first support holder 3 and the second support holder 4 may be arranged in the form of a quadrangular prism, or the first support holder 3 and the second support holder 4 may be arranged in the form of a pentagonal prism, or the first support holder 3 and the second support holder 4 may be arranged in the form of a hexagonal prism, or the first support holder 3 and the second support holder 4 may be arranged in the form of an irregular shape, or the first support holder 3 and second support holder 4 may be arranged in the form of other suitable shapes, which are not limited herein.

Referring to FIG. 4, in an optional embodiment, the at least one physiotherapy tool 2 is a temperature lowering and pain relief tool 10. The temperature lowering and pain relief tool 10 includes a detachable temperature lowering component 11. In this way, by means of temperature lowering on the sole, it is possible to effectively relieve plantar fasciitis or relieve the pain or discomfort of the sole caused by exercise, thereby improving the physiotherapy effect on the sole. In other embodiments, the temperature lowering and pain relief tool 10 may include a non-detachable temperature lowering component 11, or the types of the physiotherapy tools 2 may not include the temperature lowering and pain relief tool 10.

In the present disclosure, the specific structure of the temperature lowering and pain relief tool 10 is not limited, and may be configured according to actual requirements. In an optional embodiment, the temperature lowering and pain relief tool 10 includes a tube 12 and at least one cap 13; the tube 12 has at least one end in communication with an internal space 14, and the cap 13 is detachably arranged at the end of the tube 12 in communication with the internal space 14; and the temperature lowering component 11 is detachably arranged in the internal space 14 of the tube 12. Based on the above structure, the temperature lowering component 11 has a simple structure, and is mounted or removed more easily and efficiently.

In the present disclosure, the material of the tube 12 is not limited, and can be configured according to actual requirements. In an optional embodiment, the tube 12 is made of stainless steel. In the present disclosure, the type of the temperature lowering component 11 is not limited, and can be configured according to actual requirements. In an optional embodiment, the temperature lowering component 11 is a bag filled with cold-set gel. When it is needed to use the temperature lowering and pain relief tool 10, the temperature lowering and pain relief tool 10 may be removed and placed in a refrigerator, and after the temperature lowering and pain relief tool 10 is cooled, the temperature lowering and pain relief tool 10 is mounted to the support structure 1, such that the temperature lowering and pain relief tool 10 can be used for foot physiotherapy.

Referring to FIG. 4, in an optional embodiment, the at least one physiotherapy tool 2 is a mace-shaped acupoint massage tool 15. The mace-shaped acupoint massage tool 15 includes a first shaft core 16 and a first massage sleeve 17, the first massage sleeve 17 is sleeved on the first shaft core 16, the first shaft core 16 is configured to be rollable, and the first massage sleeve 17 is provided with multiple bumps 18 of different sizes. In this way, when it is needed to use the mace-shaped acupoint massage tool 15, the user's foot steps on and presses and rolls the first massage sleeve 17 and may feel moderate pain, and the impact is directly applied to the acupoints in the sole to fully stimulate the body repair function, thereby improving the physiotherapy effect of the foot physiotherapy device on the sole. In other embodiments, the mace-shaped acupoint massage tool 15 may have other suitable structures instead of the above structure, which is not limited herein.

Referring to FIG. 6, in an optional embodiment, the at least one physiotherapy tool 2 is an oval hammer massage tool 19. The oval hammer massage tool 19 includes a second shaft core 20 and a second massage sleeve 21, the second massage sleeve 21 is sleeved on the second shaft core 20, the second shaft core 20 is configured to be rollable, and the second massage sleeve 21 is provided with oval protrusions 22. In this way, when it is needed to use the mace-shaped acupoint massage tool 15, the user's foot steps on and presses and rolls the second massage sleeve 21, and the impact concentrates on the plantar fascia, which can fully press and stretch the fascia, promote blood circulation, and stimulate self-repair of the fascia, thereby improving the physiotherapy effect of the foot physiotherapy device on the sole. In other embodiments, the oval hammer massage tool 19 may use other suitable structures instead of the above structure, which is not limited herein.

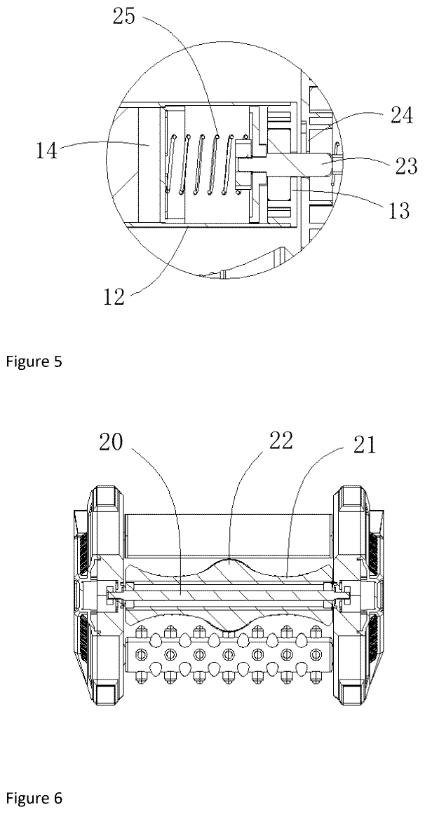

Referring to FIGS. 4 and 5, in an optional embodiment, at least one physiotherapy tool 2 is provided with movable members 23 on two ends; the support structure 1 is provided with at least one retaining structure 24; when the movable member 23 is moved into the corresponding retaining structure 24, the retaining structure 24 can limit the longitudinal movement of the movable member 23; and after the movable member 23 is separated from the retaining structure 24, the movable member 23 can move longitudinally. In this way, when it is needed to mount or remove the physiotherapy tool 2, the physiotherapy tool 2 can be mounted or removed by means of only moving the movable members 23, such that the operation is easy and efficient. In other embodiments, the at least one physiotherapy tool 2 may be provided with a movable member 23 on at least one end, and the other end thereof is detachably arranged on the support structure 1; and other suitable detachable structures may be used instead of the above solution, which is not limited herein.

In an optional embodiment, a first elastic structure 25 is provided on the end of the physiotherapy tool 2 provided with the movable member 23, the movable member 23 abuts against the first elastic structure 25, the first elastic structure 25 is compressed when the movable member 23 is pressed to move toward the center of the physiotherapy tool 2, and the first elastic structure 25 pushes the movable member 23 to reset after the pressing stops. In this way, when it is needed to mount the physiotherapy tool 2, the movable member 23 is pressed, the first elastic structure 25 is compressed, the movable member 23 is aligned with the retaining structure 24, the movable member 23 is then released, and the first elastic structure 25 pushes the movable member 23 to reset, such that the movable member 23 can be moved into the retaining structure 24 to finish the mounting of the physiotherapy tool 2. When it is needed to remove the physiotherapy tool 2, the movable member 23 is pressed, the first elastic structure 25 is compressed, and then the movable member 23 can be removed from the retaining structure 24 to finish the removal of the physiotherapy tool 2. The operation is easier, thereby improving the user experience. In other embodiments, it is possible to provide no first elastic structure 25 on the end of the physiotherapy tool 2 provided with the movable member 23.

Referring to FIGS. 1 and 4, in an optional embodiment, the support structure 1 is provided with a pressing device 26. The pressing device 26 includes a pressing member 27 and a second elastic structure 28, the pressing member 27 abutting against the second elastic structure 28. When the pressing device 26 is pressed, the second elastic structure 28 is compressed, and the pressing member 27 can push the movable member 23 to move toward the center of the physiotherapy tool 2; and after the pressing on the pressing device 26 stops, the second elastic structure 28 pushes the pressing member 27 to reset. Based on the above structure, the removal operation of the physiotherapy tool 2 is easier and more efficient. In other embodiments, the support structure 1 may be provided with no pressing device 26.

Referring to FIG. 1, in an optional embodiment, the support structure 1 is provided with a guide groove 29, and the movable member 23 can be removed along the guide groove 29 after the movable member 23 is separated from the retaining structure 24. In this way, the removal of physiotherapy tool 2 is more stable, thereby improving the user experience. In other embodiments, the support structure 1 may be provided with no guide groove 29.

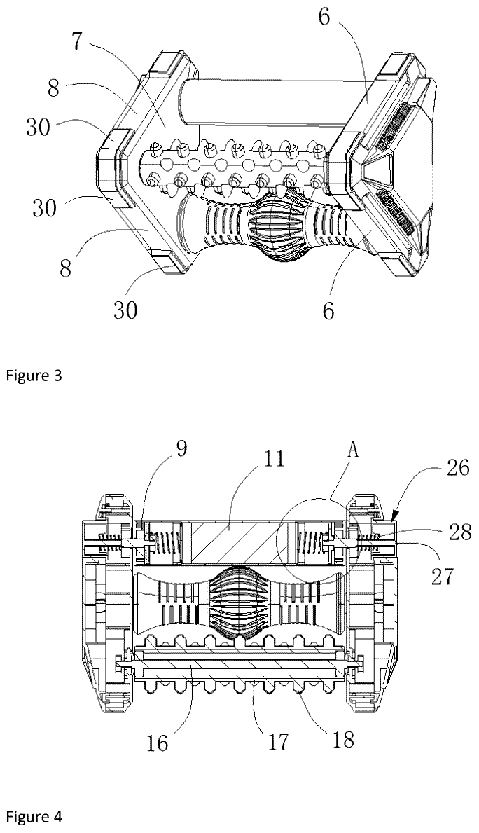

In some application scenarios, on a slippery floor, there is insufficient friction between the foot physiotherapy device and the floor, such that during use of the foot physiotherapy device by the user, the foot physiotherapy device slides over the floor, which affects the usage effect of the foot physiotherapy device. Therefore, referring to FIGS. 2 and 3, in an optional embodiment, the support structure 1 is provided with anti-slip structures 30 on two ends of each support surface, which can improve the anti-slip effect of the foot physiotherapy device and can ensure the normal use of the foot physiotherapy device. In other embodiments, the anti-slip structures 30 are provided on the entire surface of each support surface of the support structure 1. The anti-slip structure 30 may be provided on one end of each support surface of the support structure 1, or the anti-slip structure 30 may be provided in the middle of each support surface of the support structure 1, or the anti-slip structure 30 is provided at other suitable parts of each support surface of the support structure 1. In other embodiments, the support structure 1 may be provided with no anti-slip structure 30 on each support surface.

Those skilled in the art can freely combine and use the above additional technical features provided that no conflict occurs.

The foregoing implementations are only preferred implementations of the present disclosure and cannot be used to limit the scope of protection of the present disclosure. All non-essential modifications and substitutions made by those skilled in the art on the basis of the present disclosure shall fall within the scope of protection of the present disclosure.

1. foot physiotherapy device, comprising a support structure and at least two physiotherapy tools, wherein each of the physiotherapy tools implements muscle massage on a sole in a different mode;
the support structure comprises a first support holder and a second support holder arranged opposite each other, the first support holder being provided with a first arrangement surface and at least two first support surfaces, and the second support holder being provided with a second arrangement surface and at least two second support surfaces;
each of the physiotherapy tools has one end arranged on the first arrangement surface, and the other end thereof is arranged on the second arrangement surface; and
the first support surfaces correspond to the second support surfaces on a one-to-one basis, each of the first support surfaces and the corresponding second support surface form stable support when supporting the foot physiotherapy device, and the different physiotherapy tools are switched to a usage position by means of changing the different first support surfaces and the different second support surfaces to support the foot physiotherapy device;
wherein one of at least two physiotherapy tools is a mace-shaped acupoint massage tool, the mace-shaped acupoint massage tool includes a first shaft core and a first massage sleeve, the first massage sleeve is sleeved on the first shaft core, and the first massage sleeve is provided with multiple bumps of different sizes; one of at least two physiotherapy tools is an oval hammer massage tool, the oval hammer massage tool includes a second shaft core and a second massage sleeve, the second massage sleeve is sleeved on the second shaft core, and the second massage sleeve is provided with oval protrusions.

2. The foot physiotherapy device according to claim 1, wherein the at least one physiotherapy tool is arranged on the support structure in a rollable manner.

3. (canceled)

4. The foot physiotherapy device according to claim 1, wherein the at least one physiotherapy tool is detachably arranged on the support structure.

5. The foot physiotherapy device according to claim 1, wherein the at least one physiotherapy tool has a component that is detachably arranged on the support structure.

6. The foot physiotherapy device according to claim 1, comprising three physiotherapy tools, wherein the first support holder and the second support holder are arranged in the form of a transverse triangular prism;
the first support holder and the second support holder are each provided with three support surfaces, the three support surfaces of the first support holder being respectively located in three transverse planes corresponding to the first support holder, and the three support surfaces of the second support holder being respectively located in three transverse planes corresponding to the second support holder; and
each of the physiotherapy tools has one end arranged at a position of the first arrangement surface close to a corner, and the other end thereof is arranged at a corresponding position of the second arrangement surface close to a corner.

7. The foot physiotherapy device according to claim 1, wherein the at least one physiotherapy tool is a temperature lowering and pain relief tool comprising a detachable temperature lowering component.

8. The foot physiotherapy device according to claim 7, wherein the temperature lowering and pain relief tool comprises a tube and at least one cap, the tube having at least one end in communication with an internal space, and the cap being detachably arranged on an end of the tube in communication with the internal space; and
the temperature lowering component is detachably arranged in the internal space of the tube.

9. The foot physiotherapy device according to claim 1, wherein at least one physiotherapy tool is provided with movable members on two ends; and
the support structure is provided with at least one retaining structure, the retaining structure is capable of limiting a longitudinal movement of the movable member when the movable member is moved into the corresponding retaining structure, and the movable member is longitudinally movable after the movable member is separated from the retaining structure.

10. The foot physiotherapy device according to claim 9, wherein a first elastic structure is provided at the end of the physiotherapy tool provided with the movable member, the movable member abuts against the first elastic structure, the first elastic structure is compressed when the movable member is pressed to move toward the center of the physiotherapy tool, and the first elastic structure pushes the movable member to reset after the pressing stops.

11. The foot physiotherapy device according to claim 10, wherein the support structure is provided with a pressing device comprising a pressing member and a second elastic structure, the pressing member abutting against the second elastic structure; and
when the pressing device is pressed, the second elastic structure is compressed, and the pressing member is capable of pushing the movable member to move toward the center of the physiotherapy tool; and after the pressing on the pressing device stops, the second elastic structure pushes the pressing member to reset.

12. The foot physiotherapy device according to claim 9, wherein the support structure is provided with a guide groove, and the movable member is removable along the guide groove after the movable member is separated from the retaining structure.

13. The foot physiotherapy device according to claim 1, wherein the support structure is provided with anti-slip structures on two ends of each of the support surfaces.
